(19) United States
(12) Patent Application Publication
(10) Pub. No.: US 2025/0256533 A1
(43) Pub. Date: Aug. 14, 2025

(54) PNEUMATIC TIRE

(71) Applicant: Sumitomo Rubber Industries, Ltd., Kobe-shi (JP)

(72) Inventors: Daiki IMAI, Kobe-shi (JP); Aya WAKIZONO, Kobe-shi (JP); Momoka MISAKI, Kobe-shi (JP)

(73) Assignee: Sumitomo Rubber Industries, Ltd., Kobe-shi (JP)

(21) Appl. No.: 19/034,271

(22) Filed: Jan. 22, 2025

(30) Foreign Application Priority Data
Feb. 14, 2024 (JP) 2024-020527

(51) Int. Cl. B60C 9/20; B60C 11/00

(52) U.S. Cl. CPC B60C 9/20; B60C 11/0008; B60C 2009/2077; B60C 2011/0025; B60C 2011/0033

(57) ABSTRACT

Provided is a pneumatic tire with a tread portion having: a reinforcing cord layer including at least one belt ply of steel cords rubberized with topping rubber; and a tread rubber forming a part of the tread portion from a ground contacting surface of the tread portion to the radially outer side of the reinforcing cord layer. A product T1×T2×La×tan δ1 is 0.33 to 1.10, wherein T1 is the thickness in mm of the tread rubber measured at the tire equator; T2 is the average thickness in mm of the or each belt ply; La is the land ratio of the ground contacting surface; and tan δ1 is the loss tangent of the tread rubber at 30 degrees C.

### TECHNICAL FIELD

The present disclosure relates to a pneumatic tire.

### BACKGROUND ART

Patent Document 1 below discloses a tire in which the thickness of the tread portion and the loss tangent of the cap rubber layer of the tread portion are specifically defined in order to improve the rolling resistance when the vehicle starts.
Patent Document 1: Japanese Patent No. 7337333

### SUMMARY OF THE INVENTION

### Problems to be Solved by the Invention

In recent years, there is a demand for improvements in the fuel efficiency/electricity efficiency of automobiles, therefore, tires attached to such automobiles are required to have further reduced rolling resistance.

Known methods for reducing the rolling resistance of tires include reducing the volume of the tread rubber, reducing the volume of the belt layer, and decreasing the loss tangent of the tread rubber.

However, no matter which of the above methods is employed, there is a tendency that small vibrations of the tires during running are transmitted to the vehicle body, and thereby ride comfort is deteriorated.

The present disclosure was made in view of the above-described circumstances, and a primary objective of the present disclosure is to provide a pneumatic tire of which rolling resistance performance can be improved without deteriorating the ride comfort performance.

### Means for Solving the Problems

According to the present disclosure, a pneumatic tire comprises a tread portion provided with:
a reinforcing cord layer including at least one belt ply of steel cords rubberized with topping rubber; and
a tread rubber forming a part of the tread portion from a ground contacting surface of the tread portion to the radially outer side of the reinforcing cord layer, wherein
a product (T1×T2×La×tan δ1) of a thickness T1 (mm) of the tread rubber measured at the tire equator, an average thickness T2 (mm) of the or each belt ply, a land ratio La of the ground contacting surface, and a loss tangent tan δ1 of the tread rubber at 30 degrees C., is in a range from 0.33 to 1.10.

### Effects of the Invention

In the pneumatic tire according to the present disclosure, as the product (T1×T2×La×tan δ1) is limited in the specific range from 0.33 to 1.10, the rolling resistance performance can be improved without deteriorating the ride comfort performance.

### BRIEF DESCRIPTION OF THE DRAWINGS

FIG. 1 is a cross-sectional view of a tire as an embodiment of the present disclosure.

FIG. 2 is a cross-sectional view of the tread portion of the tire shown in FIG. 1.

FIG. 3 is a developed view showing an example of the arrangement of the cords of the reinforcing cord layer of the tire shown in FIG. 1.

FIG. 4 is a schematic cross-sectional view of an example of the steel cord.

### DETAILED DESCRIPTION OF THE INVENTION

Embodiments of the present disclosure will now be described in detail in conjunction with accompanying drawings.

The drawings may contain exaggerations and dimensional ratios different from the actual ratios in order to aid the understanding of the present disclosure.

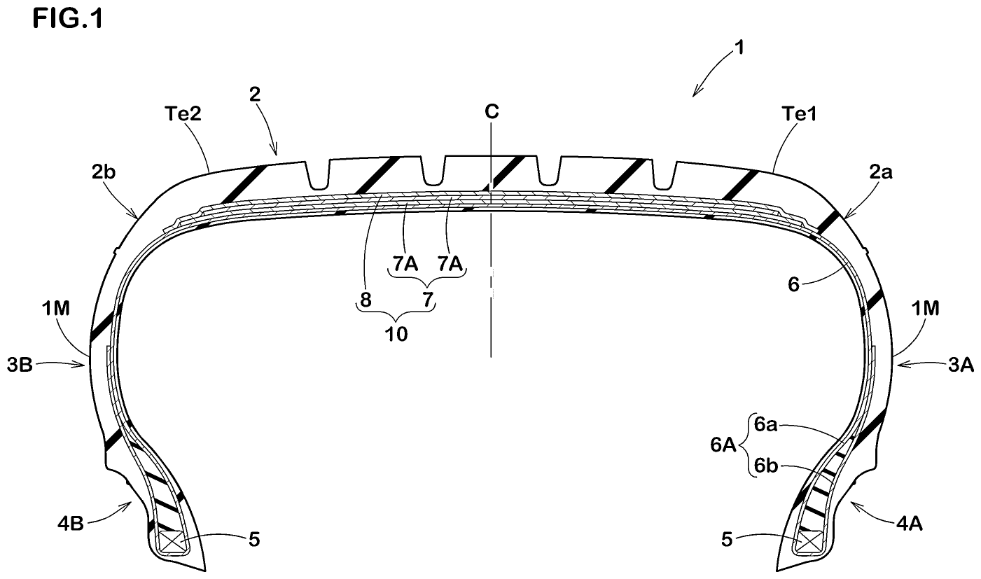

FIG. 1 shows a tire meridian cross-sectional view including the tire rotation axis, of a pneumatic tire 1 as an embodiment of the present disclosure, under its standard state. The present disclosure can be applied to pneumatic tires, in particular, suitably applied to passenger car tires although the present disclosure can be applied to tires in other categories, for example, heavy duty tires such as truck/bus tires. Thus, taking a pneumatic tire for a passenger car as an example, the embodiment will be described below.

In the case that, as in the present embodiment, the tire 1 according to the present disclosure is a type of pneumatic tire for which various standards have been established, the standard state is a state of the tire which is mounted on a standard heel rim and inflated to a standard inner pressure but loaded with no tire load.

In the case that the tire 1 is a tire for which various standards are not yet established, the “standard state” means a standard usage state depending on the purpose of use of the tire and in a condition in which the tire is not attached to a vehicle and no tire load is applied.

In this application including specification and claims, dimensions and positions of each part or portion of the tire refer to those under the standard state unless otherwise noted,

The “standard wheel rim” is a wheel rim specified for the tire in a standard system including standards on which the tire is based, for example, the “Standard rim” in JATMA, “Design Rim” in TRA, “Measuring Rim” in ETRTO.

The “standard tire pressure” is the air pressure specified for the tire in a standard system including standards on which the tire is based, for example, the “maximum air pressure” in JATMA, “INFLATION PRESSURE” in ETRTO, and the maximum air pressure listed in the table “TIRE LOAD LIMITS AT VARIOUS COLD INFLATION PRESSURES” in TRA.

The tire 1 comprises a tread portion 2, a first sidewall portion 3A, a second sidewall portion 3B, a first bead portion 4A and a second bead portion 4B.

The first sidewall portion 3A extends radially inwardly from a first end 2a in the tire axial direction of the tread portion 2 (right side end in each figure in this application). The second sidewall portion 3B extends radially inwardly from a second end 2b in the tire axial direction of the tread portion 2 (left side end in each figure in this application). The first sidewall portion 3A and the second sidewall portion 3B each include a tire maximum width position 1M on the axially outer surface.

The first bead portion 4A is continuous from the radially inner end of the first sidewall portion 3A. The second bead portion 4B is continuous from the radially inner end of the second sidewall portion 3B.

The tire 1 comprises a carcass 6 extending from the first bead portion 4A to the second bead portion 4B through the first sidewall portion 3A, the tread portion 2 and the second sidewall portion 3B.

The carcass 6 in the present embodiment is composed of one carcass ply 6A. The carcass ply 6A in this example is composed of a main body portion 6a and turned-up portions 6b. The main body portion 6a extends from the first bead portion 4A to the second bead portion 4B. The turned-up portions 6b are continuous from the main body portion 6a and are folded back in the respective bead portions 4A and 4B around the respective bead cores 5 from the inner side to the outer side in the tire axial direction.

The carcass ply 6A comprises a plurality of carcass cords and a topping rubber covering these cords (not shown).

As the carcass cords, for example, organic fiber cords such as aramid or rayon can be used. The carcass cords are preferably arranged at an angle of 70 to 90 degrees with respect to the tire equator C, for example. The tire 1 in the present embodiment has a radial carcass ply structure.

Note that, in this specification, numerical ranges for values of various parameters mean numerical ranges for average values of the respective parameters, unless otherwise specified.

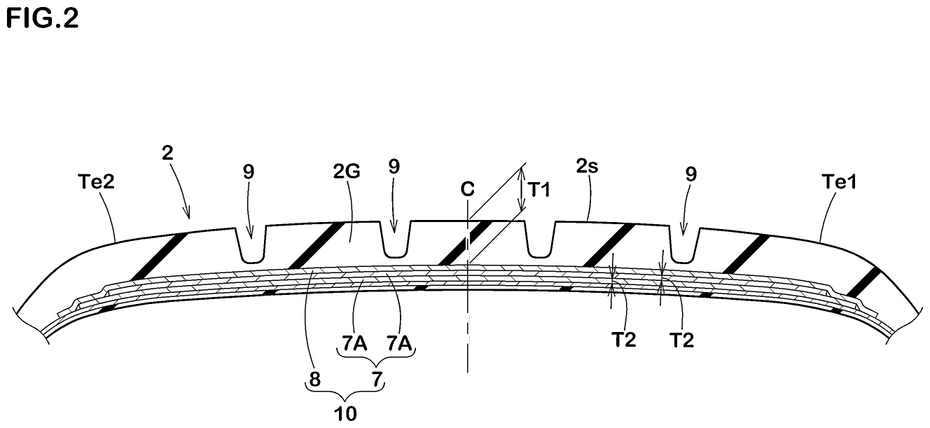

FIG. 2 shows a cross-sectional view of the tread portion 2 of the tire 1 shown in FIG. 1. As shown, the tread portion 2 in the present embodiment is provided with a reinforcing cord layer 10. The reinforcing cord layer 10 is disposed on the outside in the tire radial direction of the carcass 6 as shown in FIG. 1.

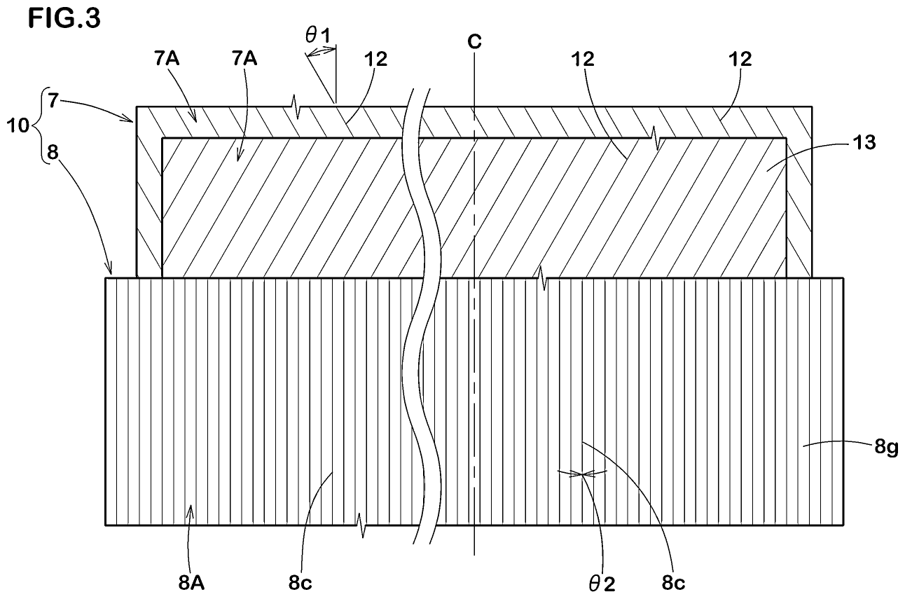

FIG. 3 shows a developed view schematically showing an example of the cord arrangement of the reinforcing cord layer 10. As shown, the reinforcing cord layer 10 in the present embodiment includes a belt layer 7 composed of at least one belt ply 7A of a plurality of steel cords 12 covered with topping rubber 13. The reinforcing cord layer 10 in the present embodiment further includes a band layer 8.

The belt layer 7 in the present embodiment is composed of radially outer and inner belt plies 7A which overlap one upon the other in the tire radial direction.

In each of the belt plies 7A, the steel cords 12 are arranged parallel with each other at an angle θ1 of 15 to 45 degrees with respect to the tire circumferential direction.

The steel cords 12 of the one belt ply 7A are inclined in the opposite direction to the steel cords 12 of the other belt ply 7A with respect to the tire circumferential direction in order to effectively reinforce the tread portion 2.

In the belt layer 7 in this example, as shown in FIG. 2, the radially inner belt ply 7A has an axial width so as to extend over substantially the entire axial width the of tread portion 2, and the radially outer belt ply 7A, which is disposed on the radially outer side of the radially inner belt ply 7A, has an axial width smaller than that of the inner belt ply 7A. Such belt layer is preferred, but the present disclosure is not to be limited to such design.

The band layer 8 in the present embodiment is composed of one band ply 8A. The band ply 8A in this example is composed of at least one band cord 8c spirally winded at an angle θ2 of not more than 5 degrees with respect to the tire circumferential direction, and a topping rubber 8g covering the at least one band cord.

The band layer 8 in the present embodiment is arranged so as to cover the entire axial width of the belt layer 7.

Preferably, the band layer 8 extends from an axially outer position than one of the axial edges of the wider belt ply 7A to an axially outer position than the other of the axial edges of the wider belt ply 7A so that the axial edges of the axially outer and inner belt plies 7A and 7A are covered with the band layer 8 as shown in FIG. 2.

The tread portion 2 comprises a tread rubber 2G which forms at least a part of the tread portion 2 from the ground contacting surface 2s of the tread portion 2 to the radially outer surface of the reinforcing cord layer 10 as shown in FIG. 2.

In FIG. 2, the tread rubber 2G is hatched as if it is composed of a single layer of rubber, but the present disclosure is not limited to such structure, the tread rubber 2G can be made up of a plurality of rubber layers.

The tread rubber 2G has a thickness T1 at the tire equator C of the tread portion 2. When a circumferential groove 9 etc. is provided at the position of the tire equator C, the thickness T1 means a thickness in a state where the circumferential groove 9 etc. is filled.

The tread rubber 2G has a loss tangent tan δ1 at 30 degrees C.

When the tread rubber 2G is made up of a plurality of rubber layers, the loss tangent tan δ1 means the average of loss tangent values of the respective rubber layers at 30 degrees C. obtained by being weighted by the respective rubber layers' volumes.

Here, the loss tangent value is measured using a viscoelastic spectrometer under the following conditions according to Japanese Industrial Standards (JIS) K6394.
Initial strain: 10%
Dynamic strain amplitude: +/−2%
Frequency: 10 Hz
Deformation mode: tension
Measuring temperature: 30 degrees C.

The tread portion 2 has first and second tread edges Te1 and Te2 which are defined as the axial outermost edges of the ground contacting patch of the tire which occurs when the tire under its standard state is contacted with a flat horizontal surface at a camber angle of 0 degrees and is loaded with a standard tire load for the tire.

The above-mentioned ground contacting surface 2s of the tread portion 2 is defined as a surface between the first and second tread edges Te1 and Te2.

In the case that the tire 1 is a type of pneumatic tire for which various standards have been established, the “standard tire load” is the load specified for the tire in a standard system including standards on which the tire is based, for example, the “maximum load capacity” in JATMA, “LOAD CAPACITY” in ETRTO, and the maximum tire load listed in the table “TIRE LOAD LIMITS AT VARIOUS COLD INFLATION PRESSURES” in TRA.

In the case that the tire 1 is a tire for which various standards are not yet established, the “standard tire load” means the maximum load that can be applied when the tire is used depending on the purpose of use.

The ground contacting surface 2s of the tread portion 2 has a land ratio La.

The land ratio La means a ratio of the actual ground contacting area to the overall area or a virtual ground contacting area in which all grooves, sipes, recesses, etc. provided in the ground contacting surface 2s are filled.

In FIG. 2, only a plurality of circumferential grooves 9 which continuously extend in the tire circumferential direction, are shown as the grooves provided in the ground contacting surface 2s. But, the ground contacting surface 2s can be provided with lateral grooves extending in the tire axial direction (not shown).

In the present disclosure, the arrangement of such grooves is not particularly limited.

In the present disclosure, a product of T1×T2×La×tan δ1 is set in a range from 0.33 to 1.10, wherein
T1 is the above-mentioned thickness (mm) of the tread rubber 2G at the tire equator C,
T2 is the average thickness (mm) of one belt ply 7A,
La is the land ratio of the ground contacting surface 2s of the tread portion, and
tan δ1 is the loss tangent of the tread rubber 2G at 30 degrees C.

Thereby, in the tire 1 according to the present disclosure, the rolling resistance performance can be improved without deteriorating the ride comfort performance.

The reason is as follows.

The above-mentioned parameters can be determined independently.

Among these parameters, the thickness T1, the thickness T2 and the land ratio La each can decrease the tire weight by making the value smaller, and it becomes possible to improve the rolling resistance performance.

As to the loss tangent tan δ1, by making the value smaller, energy loss during rolling of the tire can be reduced more, and the rolling resistance performance can be improved.

That is, in each of the parameters T1, T2, La and tan δ1, by making the value smaller, the more improved rolling resistance performance can be obtained due to the above-explained mechanism.

However, when the value of each parameter becomes smaller, small vibrations of the tire during running become more easily transmitted to the vehicle body, and the ride comfort performance becomes liable to be deteriorated.

On the other hand, when the value of each of the parameters T1, T2, La and tan δ1 is increased, the ride comfort performance can be expected to improve, but the rolling resistance performance is liable to be deteriorated.

The inventors investigated the degree of change between each parameter and the rolling resistance performance and ride comfort performance.

As a result, it was discovered that at least within numerical ranges of the parameters in which the respective parameters are applicable to the normal tires (hereinafter referred to as the “applicable range”), the transient characteristics of the rolling resistance performance and ride comfort performance are similar between the parameters.

Further, as a result of more detailed investigation, it was discovered that the degree of the similarity described above is quite high, therefore, even if the parameters are multiplied and the product is treated as one parameter, there is no problem in controlling the rolling resistance performance and ride comfort performance.

In the present disclosure, based on the above-explained findings, the product T1×T2×La×tan δ1 is set within the specifically-defined range from 0.33 to 1.10.

As a result, the rolling resistance performance can be improved without deteriorating the ride comfort performance.

If the product T1×T2×La×tan δ1 is smaller than 0.33, the small vibrations of the tire will be easily sensed by the driver, and the ride comfort performance is deteriorated.

If the product T1×T2×La×tan δ1 is increased more than 1.10, further improvement in rolling resistance performance becomes no longer expected although the ride comfort performance is maintained.

In the present disclosure, an applicable range for the thickness T1 is 7 to 15.5 mm,
an applicable range for the thickness T2 is 0.5 to 2.0 mm,
an applicable range for the land ratio La is 0.40 to 0.95, and
an applicable range for the loss tangent tan δ1 is 0.10 to 0.30.

In the present disclosure, at least when these parameters are respectively within the above applicable ranges, the above-described effects can be expected.

Hereinafter, the present embodiment will be described in more detail. Each configuration described below represents a specific aspect of the present embodiment. Therefore, the present disclosure can exhibit the above-described effects even if it does not have the configuration described below. Further, even if any one of the configurations described below is applied singly to the tire of the present disclosure having the features described above, an improvement in performance corresponding to each configuration can be expected. Furthermore, when some of the respective configurations described below are applied in combination, it is possible to expect a combined improvement in performance according to the respective configurations.

In order to reliably obtain the above-described effects, it is preferable that the parameters T1, T2, La and tan δ1 are set so that the product T1×T2×La×tan δ1 falls within a range from 0.50 to 1.00.

On the other hand, even if the thickness T2 is excluded from the parameters constituting the product T1×T2×La×tan δ1, similar effects can be expected.

For that purpose, it is possible to adopt a product of T1×La×tan δ1 which is preferably set in a range from 0.51 to 1.12.

The loss tangent tan δ1 is preferably not less than 0.12, more preferably not less than 0.14, but preferably not more than 0.22, more preferably not more than 0.20. Thereby, the heat generation of the tread portion 2 is optimized while reliably maintaining the ride comfort performance, and also the road noise reduction can be expected.

The land ratio La is preferably not less than 0.60, more preferably not less than 0.64, but preferably not more than 0.78, more preferably not more than 0.68.

Thereby, the ride comfort performance and rolling resistance performance are improved in a well-balanced manner.

From the similar point of view, the thickness T1 is preferably not less than 9.0 mm, more preferably not less than 9.5 mm, but preferably not more than 12.0 mm, more preferably not more than 11.6 mm.

The thickness T2 is preferably not more than 1.20 mm, more preferably not more than 1.00 mm. In the present embodiment, the thickness T2 is more preferably set in a range from 0.66 to 0.98 mm. In the present embodiment, for each of the two belt plies 7A, the thickness T2 is set in the above range.

The belt layer 7 composed of such belt ply or plies 7A can achieve a weight reduction while exhibiting the reinforcing effect on the tread portion 2, and the rolling resistance performance can be reliably improved.

From a similar point of view, it is preferable that the weight per unit area of one belt ply 7A is 1350 to 1980 g/sq·m.

Further, it is preferable that the weight of the topping rubber included per unit area of one belt ply 7A is 600 to 1300 g/sq·m.

It is preferable that, as shown in FIG. 3, one belt ply includes 40 to 60 steel cords 12 per 5 cm width (width in the direction perpendicular to the length direction of the parallel steel cords 12).

As to the material of the steel cords 12, there is used one of high-strength steel materials such as a so-called ST material (super tensile material) by which a tensile strength of 3,600 MPa or more can be expected; a so-called UT material (ultra tensile material) by which a tensile strength of 4,000 MPa or more can be expected; and a so-called MT material (mega tensile materials) by which a tensile strength of 4,500 MPa or more can be expected.

For this purpose, it is preferable that the carbon content of the material of the steel cords 12 is 0.79% to 1.00%. In the present disclosure, however, the steel cords 12 are not limited to such materials.

The strength of each steel cord 12 is preferably in a range from 350 to 540N. The outer diameter of each steel cord 12 is preferably in a range from 0.22 to 0.55 mm. Thereby, it is possible to reduce the weight of the tire while ensuring the reinforcing effect on the tread portion 2 by the belt layer 7, and as a result, the rolling resistance performance can be improved.

The strength is measured according to a measuring method prescribed in Japanese Industrial Standards (JIS) G3510.

In the present embodiment, the steel cords 12 each have a lxi structure, which means that the cord is a monofilament (not shown).

For example, the outer diameter of the monofilament is in a range from 0.30 to 0.50 mm.

In the present disclosure, however, the steel cord 12 is not limited to the 1×1 cord structure.

Each steel cord 12 may have a 1×n cord structure consisting of a number (n) of filaments 15.

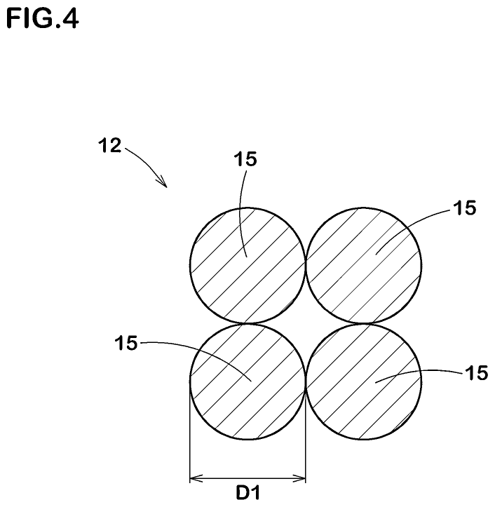

FIG. 4 shows a cross-sectional view of another example of the steel cord 12 which can be employed in the present embodiment. This cord 12 has a 1×4 cord structure. For example, the outer diameter D1 of each filaments 15 is set in a range from 0.15 to 0.30 mm. Thereby, the ride comfort performance and rolling resistance performance can be improved in a well-balanced manner.

While detailed description has been made of a preferable embodiment of the present disclosure, the present disclosure can be embodied in various forms without being limited to the illustrated embodiment.

### Comparison Tests

Based on the structure shown in FIG. 1, pneumatic tires of size 205/55R16 having specifications shown in Tables 1 and 2 were experimentally manufactured as test tires including Example tires Ex1-Ex20 and Comparative tires Ref1-Ref4.

All the test tires were substantially the same except for the parameters T1, T2, La and tan δ1 and the product value.

The test tires were mounted on wheel rims of size 16×6.5 and inflated to 250 kPa, and then tested for the rolling resistance performance and ride comfort performance.

### <Rolling Resistance Performance Test>

Using a rolling resistance test machine, the rolling resistance of each test tire was measured. The measured results were converted into index numbers wherein the smaller the numerical value, the lower the rolling resistance.

### <Ride Comfort Performance Test>

Using a 2000 cc front engine front wheel drive test car with the test tires attached to all wheels, a test driver evaluated the ride comfort performance when running on a test course, and the results were indicated by an index wherein the larger the number, the better the ride comfort performance.

The test results are shown in Tables 1 and 2.

TABLE 1

| Tire | Ref1 | Ref2 | Ref3 | Ref4 | Ex1 | Ex2 |
|---|---|---|---|---|---|---|
| Tread rubber thickness | 11.6 | 11.6 | 8.5 | 9.0 | 9.5 | 9.7 |
| T1(mm) | | | | | | |
| Belt ply thickness | 0.66 | 0.98 | 0.66 | 0.66 | 0.66 | 0.66 |
| T2(mm) | | | | | | |
| Land ratio La | 0.78 | 0.78 | 0.40 | 0.50 | 0.60 | 0.64 |
| Tread rubber tanδ1 | 0.23 | 0.28 | 0.14 | 0.10 | 0.15 | 0.14 |
| T1 × T2 × La × tanδ1 | 1.37 | 2.48 | 0.31 | 0.30 | 0.56 | 0.57 |
| T1 × T2 × La | 2.08 | 2.53 | 0.48 | 0.45 | 0.86 | 0.87 |
| Rolling resistance | 8.1 | 8.6 | 5.8 | 5.7 | 6.5 | 6.7 |
| Ride comfort | 50 | 50 | 45 | 45 | 60 | 60 |
| Tire | Ex3 | Ex4 | Ex5 | Ex6 | Ex7 | Ex8 |
| Tread rubber thickness | 9.5 | 9.7 | 8.5 | 9.5 | 10.5 | 11.0 |
| T1(mm) | | | | | | |
| Belt ply thickness | 0.98 | 0.98 | 0.66 | 0.70 | 0.75 | 0.98 |
| T2(mm) | | | | | | |
| Land ratio La | 0.65 | 0.68 | 0.55 | 0.70 | 0.70 | 0.64 |
| Tread rubber tanδ1 | 0.18 | 0.17 | 0.11 | 0.15 | 0.16 | 0.16 |
| T1 × T2 × La × tanδ1 | 1.09 | 1.10 | 0.34 | 0.70 | 0.88 | 1.10 |
| T1 × T2 × La | 1.11 | 1.12 | 0.51 | 1.00 | 1.18 | 1.13 |
| Rolling resistance | 6.8 | 7.0 | 6.2 | 6.7 | 7.2 | 7.4 |
| Ride comfort | 60 | 60 | 55 | 65 | 65 | 70 |

TABLE 2

| Tire | Ex9 | Ex10 | Ex11 | Ex12 | Ex13 | Ex14 |
|---|---|---|---|---|---|---|
| Tread rubber thickness | 7.5 | 9.0 | 12.0 | 13.0 | 9.5 | 9.5 |
| T1(mm) | | | | | | |
| Belt ply thickness | 0.66 | 0.66 | 0.66 | 0.66 | 0.50 | 0.60 |
| T2(mm) | | | | | | |
| Land ratio La | 0.45 | 0.60 | 0.80 | 0.85 | 0.60 | 0.60 |
| Tread rubber tanδ1 | 0.15 | 0.15 | 0.15 | 0.15 | 0.15 | 0.15 |
| T1 × T2 × La × tanδ1 | 0.33 | 0.53 | 0.95 | 1.09 | 0.43 | 0.51 |
| T1 × T2 × La | 0.51 | 0.81 | 1.44 | 1.66 | 0.86 | 0.86 |
| Rolling resistance | 6.0 | 6.5 | 7.2 | 7.5 | 6.3 | 6.4 |
| Ride comfort | 55 | 60 | 70 | 75 | 60 | 60 |
| Tire | Ex15 | Ex16 | Ex17 | Ex18 | Ex19 | Ex20 |
| Tread rubber thickness | 9.5 | 9.5 | 9.5 | 9.5 | 9.5 | 9.5 |
| T1(mm) | | | | | | |
| Belt ply thickness | 1.00 | 1.20 | 0.66 | 0.66 | 0.66 | 0.66 |
| T2(mm) | | | | | | |
| Land ratio La | 0.60 | 0.60 | 0.60 | 0.60 | 0.60 | 0.60 |
| Tread rubber tanδ1 | 0.15 | 0.15 | 0.10 | 0.12 | 0.25 | 0.27 |
| T1 × T2 × La × tanδ1 | 0.86 | 1.03 | 0.38 | 0.45 | 0.94 | 1.02 |
| T1 × T2 × La | 0.86 | 0.86 | 0.57 | 0.68 | 1.43 | 1.54 |
| Rolling resistance | 6.7 | 7.0 | 6.0 | 6.1 | 7.2 | 7.3 |
| Ride comfort | 60 | 60 | 60 | 60 | 60 | 60 |

As shown in Tables 1 and 2, as the Comparative tires Ref1 and Ref2 had large product values (T1×T2×La×tan δ1), the rolling resistance performance became 8.1 to 8.6. On the other hand, as the Comparative tires Ref3 and Ref4 had smaller product values (T1×T2×La×tan δ1), the rolling resistance performance was improved, but the ride comfort performance became 45. In the Example tires Ex1 to Ex20, as the product values (T1×T2×La×tan δ1) were set in the specifically-defined range, the rolling resistance performance was improved and reduced to 6.2 to 7.3, while maintaining the ride comfort performance at high levels of from 55 to 70. Thus, it was confirmed that the tires according to the present disclosure can be improved in rolling resistance performance without deteriorating the ride comfort performance.

### Statement of the Present Disclosure

The present disclosure is as follows:

### [Present Disclosure 1]

A pneumatic tire comprising a tread portion, the tread portion comprising:
a reinforcing cord layer including at least one belt ply of steel cords rubberized with topping rubber; and
a tread rubber forming a part of the tread portion from a ground contacting surface of the tread portion to the radially outer side of the reinforcing cord layer,
wherein
   a product (T1×T2×La×tan δ1) of the thickness T1 (mm) of the tread rubber measured at the tire equator, the average thickness T2 (mm) of the or each belt ply, the land ratio La of the ground contacting surface, and the loss tangent tan δ1 of the tread rubber at 30 degrees C., is in a range from 0.33 to 1.10.

### [Present Disclosure 2]

The pneumatic tire according to Present Disclosure 1, wherein the thickness T2 is 0.66 to 0.98 mm.

### [Present Disclosure 3]

The pneumatic tire according to Present Disclosure 1 or 2, wherein a product (T1×La×tan δ1) of the thickness T1 (mm), the land ratio La, and the loss tangent tan δ1 is 0.51 to 1.12.

### [Present Disclosure 4]

The pneumatic tire according to any one of Present Disclosures 1 to 3, which is a passenger car tire provided with a carcass of a radial ply structure in which carcass cords are arranged at an angle of 70 to 90 degrees with respect to the tire equator.

### [Present Disclosure 5]

The pneumatic tire according to any one of Present Disclosures 1 to 4, wherein the reinforcing cord layer includes: a belt layer composed of radially outer and inner belt plies which overlap one upon the other in the tire radial direction; and a band layer disposed radially outside the belt layer and composed of at least one band cord arranged at an angle of not more than 5 degrees with respect to the tire circumferential direction.

### [Present Disclosure 6]

The pneumatic tire according to any one of Present Disclosures 1 to 5, wherein the steel cord has an outer diameter in a range from 0.22 to 0.55 mm.

### [Present Disclosure 7]

The pneumatic tire according to any one of Present Disclosures 1 to 6, wherein the steel cord is a monofilament having an outer diameter of 0.30 to 0.50 mm and has a 1×1 cord structure.

### [Present Disclosure 8]

The pneumatic tire according to any one of Present Disclosures 1 to 7, wherein the steel cord has a 1×n cord structure and consists of a number n of filaments each having an outer diameter of 0.15 to 0.30 mm.

### [Present Disclosure 9]

The pneumatic tire according to any one of Present Disclosures 1 to 8, wherein the steel cord has a strength in a range from 350N to 540N.

### [Present Disclosure 10]

The pneumatic tire according to any one of Present Disclosures 1 to 9, wherein the material of the steel cord has a carbon content of 0.79% to 1.00%.

### [Present Disclosure 11]

The pneumatic tire according to any one of Present Disclosures 1 to 10, wherein the or each belt ply has a cord count of 40 to 60 steel cords per 5 cm width.

### DESCRIPTION OF THE REFERENCE SIGNS

2 tread portion
2s ground contacting surface
2G tread rubber
12 steel cord
13 topping rubber
7A belt ply
10 reinforcing cord layer
T1 tread rubber thickness at tire equator
T2 average thickness of one belt ply

1. A pneumatic tire comprising a tread portion provided with:
a reinforcing cord layer including at least one belt ply of steel cords rubberized with topping rubber; and
a tread rubber forming a part of the tread portion from a ground contacting surface of the tread portion to the radially outer side of the reinforcing cord layer,
wherein
a product (T1×T2×La×tan δ1) of
the thickness T1 (mm) of the tread rubber measured at the tire equator,
the average thickness T2 (mm) of the or each belt ply,
the land ratio La of the ground contacting surface, and
the loss tangent tan δ1 of the tread rubber at 30 degrees C.,
is in a range from 0.33 to 1.10.

2. The pneumatic tire according to claim 1, wherein
the thickness T2 is 0.66 to 0.98 mm.

3. The pneumatic tire according to claim 2, wherein
a product (T1×La×tan δ1) of the thickness T1 (mm), the land ratio La, and the loss tangent tan δ1 is 0.51 to 1.12.

4. The pneumatic tire according to claim 3, which is a passenger car tire provided with a carcass of a radial ply structure in which carcass cords are arranged at an angle of 70 to 90 degrees with respect to the tire equator.

5. The pneumatic tire according to claim 4, wherein
the reinforcing cord layer includes: a belt layer composed of radially outer and inner belt plies which overlap one upon the other in the tire radial direction; and a band layer disposed radially outside the belt layer and composed of at least one band cord arranged at an angle of not more than 5 degrees with respect to the tire circumferential direction.

6. The pneumatic tire according to claim 1, wherein
the steel cords each have an outer diameter in a range from 0.22 to 0.55 mm.

7. The pneumatic tire according to claim 2, wherein
the steel cords each have an outer diameter in a range from 0.22 to 0.55 mm.

8. The pneumatic tire according to claim 5, wherein
the steel cords each have an outer diameter in a range from 0.22 to 0.55 mm.

9. The pneumatic tire according to claim 1, wherein
each of the steel cords is a monofilament having an outer diameter of 0.30 to 0.50 mm and having a 1×1 cord structure.

10. The pneumatic tire according to claim 2, wherein
each of the steel cords is a monofilament having an outer diameter of 0.30 to 0.50 mm and having a 1×1 cord structure.

11. The pneumatic tire according to claim 5, wherein
each of the steel cords is a monofilament having an outer diameter of 0.30 to 0.50 mm and having a 1×1 cord structure.

12. The pneumatic tire according to claim 6, wherein
each of the steel cords is a monofilament having an outer diameter of 0.30 to 0.50 mm and having a 1×1 cord structure.

13. The pneumatic tire according to claim 1, wherein
the steel cords each have a 1×n cord structure consisting of a number n of filaments each having an outer diameter of 0.15 to 0.30 mm.

14. The pneumatic tire according to claim 2, wherein
the steel cords each have a 1×n cord structure consisting of a number n of filaments each having an outer diameter of 0.15 to 0.30 mm.

15. The pneumatic tire according to claim 5, wherein
the steel cords each have a 1×n cord structure consisting of a number n of filaments each having an outer diameter of 0.15 to 0.30 mm.

16. The pneumatic tire according to claim 6, wherein
the steel cords each have a 1×n cord structure consisting of a number n of filaments each having an outer diameter of 0.15 to 0.30 mm.

17. The pneumatic tire according to claim 1, wherein
the steel cords each have a strength in a range from 350N to 540N.

18. The pneumatic tire according to claim 1, wherein
the material of the steel cord has a carbon content of 0.79% to 1.00%.

19. The pneumatic tire according to claim 12, wherein
the steel cords of the/each belt ply have a cord count of 40 to 60 cords per 5 cm width.

20. The pneumatic tire according to claim 16, wherein
the steel cords of the/each belt ply have a cord count of 40 to 60 cords per 5 cm width.
